(19) United States
(12) Patent Application Publication
(10) Pub. No.: US 2026/0229815 A1
(43) Pub. Date: Aug. 6, 2026

(54) CONNECTION APPARATUS

(71) Applicant: Baker Hughes Energy Technology UK Limited, Bristol (GB)

(72) Inventor: Jerzy Rafal FABIANSKI, Stord (NO)

(21) Appl. No.: 19/149,338

(22) PCT Filed: Jan. 18, 2024
(86) PCT No.: PCT/EP2024/025031

§ 371 Date: Jul. 18, 2025

(30) Foreign Application Priority Data
Jan. 23, 2023 (GB) 2300978.0

(51) Int. Cl. H01R 13/523; G02B 6/38; G02B 6/50; H01R 13/629; H01R 43/26

(52) U.S. Cl. CPC H01R 13/523; G02B 6/3873; G02B 6/506; H01R 13/629; H01R 43/26

(57) ABSTRACT

A connection apparatus for forming a connection between respective service lines in a subsea environment is disclosed. The connection apparatus comprises a first part comprising a plurality of connectors configured to be connected to a first set of service lines and a first mount the plurality of connectors being disposed on and depending from the first mount wherein at least one of the plurality of connectors is a hot stab The connection apparatus comprises a second part comprising a plurality of receptacles configured to be connected to a second set of service lines, and a second mount the plurality of receptacles being disposed on and depending from the second mount each receptacle of the plurality of receptacles corresponding to a connector of the plurality of connectors wherein at least one of the plurality of receptacles is a hot stab receptacle.

### TECHNICAL FIELD

The present disclosure relates to apparatus and methods for forming connections between service lines (including for example hydraulic, electric or fibre-optic service lines) for use in a subsea environment. The service lines may be used to control oil and gas production equipment or carbon storage equipment located in a subsea environment.

### BACKGROUND

In various subsea applications including the field of subsea oil and gas production, and the field of subsea sCO2 re-injection, there is a need to provide connections between different structure or installations. These connections are typically provided by service lines and may include service lines for at least power delivery, control signals and product delivery. In various examples, hydraulic fluids, electrical and/or fibre optic signals may be required to be sent between a subsea structure and another structure, such as for example a vessel located above the surface or a rig. Typically, connections such as hot stabs and stab plates are used to connect hydraulic service lines together, for example to provide a connection between a subsea structure and another structure. The hot stab and stab plate connections are provided separately and require individual connection by a Remote Operated Vehicle (ROV). For example, multiple separate hot stabs and stab plates may require to be connected one at a time, such that rapid connection and disconnection in a subsea environment using these connections is not possible.

The present disclosure provides a connection apparatus and a method of making and connecting the connection apparatus which seek to overcome these problems.

### SUMMARY

From a first aspect, the disclosure provides a connection apparatus for forming a connection between respective service lines in a subsea environment, the connection apparatus comprising a first part comprising a plurality of connectors configured to be connected to a first set of service lines, and a first mount, the plurality of connectors being disposed on and depending from the first mount, wherein at least one of the plurality of connectors is a hot stab. The connection apparatus comprises a second part comprising a plurality of receptacles configured to be connected to a second set of service lines, and a second mount, the plurality of receptacles being disposed on and depending from the second mount, each receptacle of the plurality of receptacles corresponding to a connector of the plurality of connectors, wherein at least one of the plurality of receptacles is a hot stab receptacle, wherein the connection apparatus is movable between a coupled position and an uncoupled position. In the coupled position, each connector of the plurality of connectors is received in its corresponding receptacle and a connection is formed between the respective service lines; and in the uncoupled position, there is no connection between the respective service lines.

It will be understood that the provision of a connection apparatus of the type described allows a plurality of connectors including at least one hot stab to be quickly and simply connected with their respective receptacles by bringing the connection apparatus into the coupled position. Further, the connection between the respective service lines can be broken in a single operation by moving the connection apparatus into the uncoupled position.

In some examples of the disclosure, the connection apparatus may include only hydraulic connectors and receptacles. For example, each of the plurality of connectors may be a hydraulic connector, at least one of the plurality of hydraulic connectors being a hot stab. In addition or alternatively, each of the plurality of receptacles may be a hydraulic receptacle, at least one of the plurality of hydraulic receptacles being a hot stab receptacle. In these examples, it will be understood that the connection apparatus may be for forming a connection between respective hydraulic service lines.

In other examples of the disclosure however, the connection apparatus may be for forming a connection between other respective service lines as well as between hydraulic service lines. In these examples, the connection apparatus may include other types of connectors and receptacles as well as one or more hot stabs and hot stab receptacles.

In some examples of the disclosure therefore, at least one of the plurality of connectors may be an electrical connector and at least one of the plurality of receptacles may be an electrical connector receptacle. In these or other examples of the disclosure therefore, at least one of the plurality of connectors may be a fibre-optic connector and at least one of the plurality of receptacles may be a fibre-optic connector receptacle.

In any example of the disclosure, the connection apparatus may be configured to move from the coupled position to the uncoupled position on application of a pre-determined force which acts to move the first and second parts away from each other. In at least some examples this may allow the connection apparatus to be held in the coupled position until such a pre-determined force is applied. This may provide a simple way of separating the various connections provided by the connection apparatus when it is required to do so.

In some examples, the connection apparatus may further comprise a locking arrangement configured to lock the connection apparatus in the coupled position. This may avoid the possibility of the connection between the various service lines being broken unexpectedly due to movement of the first and second parts relative to each other. This may be especially helpful in a subsea environment in which the connection apparatus may be subjected to significant forces for example due to adverse weather conditions.

In some examples, the locking arrangement may be configured to release on application of the pre-determined force. This could be achieved by any suitable mechanism including for example a spring mechanism biasing the first and second parts together or a bond or weld configured to break at a predetermined application of force. In some examples however, the locking arrangement may comprise a shear pin.

It will be understood that each of the connectors may need to be aligned with its respective receptacle for the connection apparatus to be moved in to the coupled position. This could be achieved manually by a user. However, in some situations including but not limited to when the connection apparatus is moved into a coupled position in a subsea environment, it may be difficult for a user to successfully adjust the position of the first and second parts relative to each other to align each of the connectors with its respective receptacle. In some examples, the connection apparatus may further comprise an alignment assembly for aligning the plurality of connectors of the first part with the plurality of receptacles of the second part.

The alignment assembly could take various different forms. In some examples, the alignment assembly may comprise a first alignment feature on the first part, and a second alignment feature on the second part, wherein the first and second alignment features are configured to engage in the coupled position.

In some examples, the first alignment feature may comprise an alignment pin. The second alignment feature may comprise an alignment receptacle which is configured to receive the alignment pin. Other alignment feature arrangements may be anticipated.

In some examples, the plurality of connectors may be positioned on the first mount and the plurality of receptacles may be positioned on the second mount such that each respective one of the plurality of connectors may be received only in a chosen one of the plurality of receptacles when the connection apparatus is in the coupled position.

In some examples, the first part may comprise a first attachment arrangement configured to attach the first part to a first structure. The second part may comprise a second attachment arrangement configured to attach the second part to a second structure. It will be understood that the attachment arrangements may be helpful, especially in a subsea environment in locating the connection apparatus and or anchoring it relative to surface and/or subsea installations or structures.

From a further aspect, the present disclosure provides a method of making a connection apparatus for forming a connection between respective service lines in a subsea environment, the method comprising: providing a first mount; attaching a plurality of connectors to the first mount so as to depend from the first mount, wherein at least one of the plurality of connectors is a hot stab; providing a second mount; and attaching a plurality of receptacles to the second mount so as to depend from the second mount, wherein each receptacle of the plurality of receptacles corresponds to a connector of the plurality of connectors, such that each of the plurality of connectors is configured to be received by one of the plurality of receptacles when the connection apparatus is moved into the coupled position.

The method may further comprise: forming a plurality of apertures in the first mount, wherein each connector is aligned with and extends from one of the plurality of apertures in the first mount. The method may comprise forming a plurality of apertures in the second mount, wherein each receptacle is aligned with and extends from one of the plurality of apertures in the second mount.

From a further aspect, the present disclosure provides a method of forming a connection between respective service lines in a subsea environment using the connection apparatus of any of the examples described above. The method comprises: connecting the plurality of connectors of the first part to a first set of service lines, connecting the plurality of receptacles of the second part to a second set of service lines, and moving the connection apparatus into the coupled position. The connection apparatus may be moved into the coupled position by moving the first part towards the second part and/or moving the second part towards the first part.

In some examples, the connection apparatus may be moved into the coupled position by an ROV or by an actuator, for example a hydraulic actuator. Other coupling methods may be anticipated, such as manual coupling, which may be carried out either subsea or above the surface of the sea.

In some examples, the method may further comprise aligning the plurality of connectors with the plurality of receptacles before or while moving the connection apparatus into the coupled position.

From a further aspect, the present disclosure provides a method of breaking a connection between respective service lines in a subsea environment, wherein the connection is formed by the connection apparatus as described in any of the above examples. The method comprises: moving the first and second part away from each other to move the connection apparatus to the uncoupled position.

The present disclosure provides an improved connection apparatus allowing multiple connectors, including at least one hot stab, to be simultaneously engaged with respective receptacles. The present disclosure allows for rapid subsea disconnection of the connection apparatus. In some examples, an alignment assembly and/or the arrangement of connectors allows for the alignment of the connection apparatus during assembly.

Although certain advantages are discussed below in relation to the features detailed above, other advantages of these features may become apparent to the skilled person following the present disclosure.

### BRIEF DESCRIPTION OF THE DRAWINGS

One or more non-limiting examples will now be described, by way of example only, and with reference to the accompanying figures in which:

FIG. 1 is a perspective view showing a connection apparatus according to an example of the disclosure;

FIG. 2 is a side view of the connection apparatus of FIG. 1;

FIG. 3 is a top view of the connection apparatus of FIG. 1;

FIG. 4A is a top view of a first mount of the connection apparatus of FIG. 1;

FIG. 4B is a top view of a second mount of the connection apparatus of FIG. 1;

FIG. 5 is a perspective view showing a connection apparatus according to a further example of the disclosure;

FIG. 6A is a top view of a first mount of the connection apparatus of FIG. 5;

FIG. 6B is a top view of a second mount of the connection apparatus of FIG. 5;

FIG. 7A is a detail front view of the alignment assembly of FIG. 1;

FIG. 7B is a detail section side view of the alignment assembly of FIG. 1; and

FIG. 8 is a schematic representation of the connection apparatus of FIG. 1.

### DETAILED DESCRIPTION

According to any examples of the disclosure, a connection apparatus for connecting a first set of service lines to a second set of service lines is provided. Thus, the connection apparatus may connect a subsea structure to another structure, in some examples a surface structure, via service lines. The connection apparatus may in other examples provide a connection between two or more subsea structures. The connection apparatus provides a means to send hydraulic signals and, in some examples, also either or both of electrical and fibre optic signals from a first set of service lines to a second set of service lines. The first and second set of service lines may act to communicate signals of the type described between subsea or other structures.

The connection apparatus comprises first and second parts. The first part comprises a plurality of connectors which connect to a first set of service lines. The first set of service lines are connected between the first part and a first structure. A first attachment arrangement connects the first part to the first structure. The first structure may, for example, be a surface structure, or subsea structure. The first part has a first mount, on which the plurality of connectors are disposed on. The plurality of connectors depend from the first mount in a first direction. The first part may comprise a first plate on which the connectors are mounted. The first plate is arranged to extend perpendicular to the first direction. At least one of the plurality of connectors is a hot stab. The connectors may be at least one hot stab, at least one electrical connector and/or at least one fibre-optic connector. In examples of the invention, the plurality of connectors comprises at least two hot stabs.

The second part comprises a plurality of receptacles which connect to a second set of service lines. The second set of service lines are connected between the second part to a second structure. A second attachment arrangement connects the second part to the second structure. The second structure is a subsea structure. The second part has a second mount, on which the plurality of receptacles are disposed on. The plurality of receptacles depend from the second mount in a second direction. The second part may comprise a second plate on which the receptacles are mounted. The second plate is arranged to extend perpendicular to the second direction. At least one of the plurality of receptacles is a hot stab receptacle. The remaining receptacles may be at least one hot stab receptacle, at least one electrical connector receptacle and/or at least one fibre-optic connector receptacle. Each receptacle on the second part corresponds to a connector on the first part.

A primary axis of the connection apparatus extends in the first direction through the connection apparatus at a first attachment arrangement on the first part and a second attachment arrangement on the second part. The hot stabs on the first part are arranged substantially evenly spaced around the primary axis. One hot stab is arranged such that it is a different distance from the primary axis to the remaining hot stabs or connectors. In an example of the invention that comprises two or more hot stabs, the hot stabs are arranged such that one is a different distance from the primary axis to the other(s). The hot stabs may be arranged asymmetrically about a plane along the primary axis. In some examples, the hot stabs may be arranged such that all hot stabs are an equal distance from the primary axis.

The connection apparatus is movable along the primary axis between a coupled and an uncoupled position. In the coupled position, each connector of the plurality of connectors on the first part is received in its corresponding receptacle on the second part to form a connection between the first and second service lines. In the uncoupled position, the service lines are disconnected. In the uncoupled position, the first and second parts may be axially separated such that the connectors are not within their corresponding receptacles. In examples, the uncoupled position may provide a condition in which the connectors are slightly within their corresponding receptacles, but not providing a connection between the first and second service lines. The connection apparatus may be coupled above the surface before being placed submerged in a subsea environment. The connection apparatus is uncoupled in a subsea environment by applying tension to separate the first and second parts (described in more detail below).

An alignment assembly is provided to provide improved assembly of the first and second parts. The alignment assembly comprises a first alignment feature on the first part, depending along the primary axis in the first direction, and a second alignment feature on the second part, depending along the primary axis in the first direction. On assembly, the first and second alignment features engage to provide an axial guide to align the connectors. The alignment features may have a locking arrangement which restricts axial separation of the first and second parts. The connection apparatus provides low friction mating of the first and second parts when moving into the coupled position to provide the connection between the first and second service lines. This allows for easy assembly of the connection apparatus, and does not require any further parts to aid assembly of the first and second part. The connection apparatus provides low friction separation of the first and second parts to break the connection between the first and second service lines. The connection apparatus provides a low break-away force for moving the connection apparatus from the coupled to the uncoupled position. The break-away force required to separate the first and second parts can be determined by the locking mechanism. The connection apparatus is coupled above the surface before being placed in a subsea environment. The connection apparatus is uncoupled subsea by applying tension to the first and second parts along the primary axis to separate the parts. In an example, the connection apparatus may be coupled and uncoupled subsea using an ROV. In an example, the connection apparatus is coupled automatically by hydraulic cylinder.

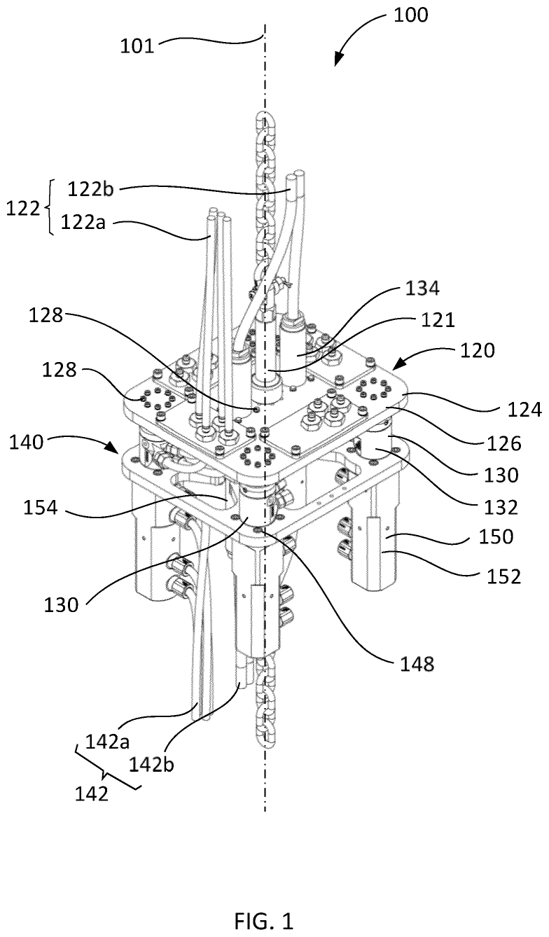

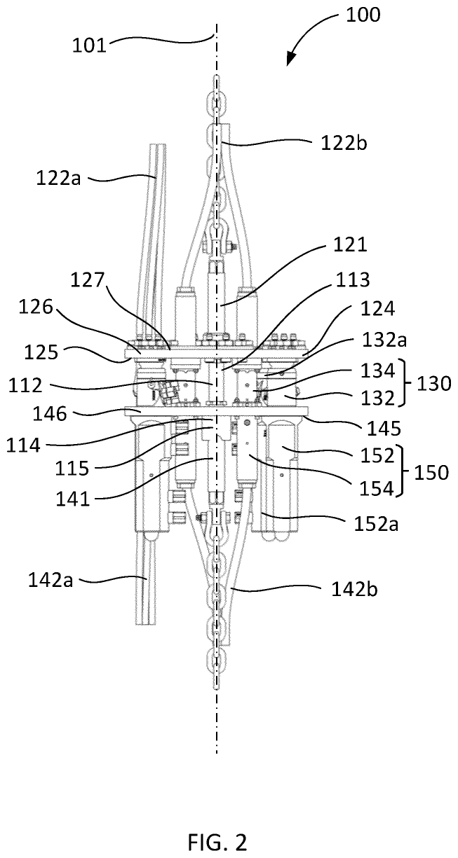

Referring to FIGS. 1 and 2, an example connection apparatus 100 is shown. The connection apparatus 100 comprises a primary axis 101 which extends centrally through the connection apparatus 100. The connection apparatus 100 comprises a first part 120 and a second part 140. The first part 120 comprises a first mount 124 and a plurality of connectors 130. The first mount 124 comprises a first plate 126 which, in the example shown, is rectangular when viewed in the axial direction. In other examples, it will be understood that the first mount may comprise a different shape. In some examples including that shown, the primary axis 101 extends through the centre (not shown) of the first plate 126.

The connectors 130 are configured to be connected to a first set of service lines 122. The connectors 130 are attached to and depend from the first plate 126, extending axially from a first side 125 of the first plate 126. When connected to the connection apparatus, as shown in FIG. 1, the first set of service lines 122 extend away from a second side 127 of the first plate 126, opposite to the first side thereof.

The connectors 130 depend or extend from the first plate 126 in a first direction. In the example shown, the first direction is parallel to the primary axis 101. At least one of the connectors 130 is a hot stab 132. In any example, at least one of the other connectors may be an electrical connector 134. In any example, at least one of the other connectors 130 may be a fibre-optic connector.

FIGS. 1 and 2 show an example connection apparatus comprising four hot stabs 132 and two electrical connectors 134. The hot stabs 132 and electrical connectors 134 are attached to the first plate 126. The first plate 126 comprises attachment holes 128 through which each hot stab 132 and electrical connector 134 is bolted to the first plate 126. In various examples, each hot stab 132 and electrical connector receptacle 134 could be attached to the first plate 126 by other means, for example by riveting or welding.

The second part 140 comprises a plurality of receptacles 150 and a second mount 144. The receptacles 150 are configured to be connected to a second set of service lines 142. The receptacles 150 are attached to and depend or extend from the second mount 144. The second mount 144 comprises a second plate 146 which in the example shown is rectangular when viewed in the axial direction. In other examples, the second mount may comprise a different shape. In some examples including that shown, the primary axis 101 extends through the centre (not shown) of the second plate 146.

The receptacles 150 depend from the second plate 146, extending axially (in a direction parallel to the primary axis 101) from a first side 145 of the second plate 146. When connected to the connection apparatus, as shown in FIG. 1, the second set of service lines 142 extend away from receptacles 150 as shown. The receptacles 150 include at least one hot stab receptacle 152 that is positioned to correspond with a hot stab 132 on the first part 120. The receptacles 150 may also include electrical connector receptacles 154. The receptacles 150 may also include fibre-optic connector receptacles (not shown).

FIGS. 1 and 2 show an example comprising four hot stab receptacles 152 and two electrical connector receptacles 154. The hot stab receptacles 152 and electrical connector receptacles 154 are attached to the second plate 146. The second plate 146 comprises attachment holes 148 through which each hot stab receptacle 152 and electrical connector receptacle 154 is bolted to the second plate 146. In other examples, each hot stab receptacle 152 and electrical connector receptacle 154 could be attached to the second plate 146 by other means, for example by riveting or welding.

The hot stabs 132 are substantially evenly circumferentially distributed around the primary axis 101. In any example of the disclosure, the plurality of connectors are positioned on the first mount and the plurality of receptacles are positioned on the second mount such that each respective one of the plurality of connectors may be received only in a chosen one of the plurality of receptacles when the connection apparatus is in the coupled position. Thus, in the example shown, one offset hot stab 132a is arranged at a distance from the axis 101 different from the distance of the other hot stabs 132 to the axis 101. The remaining hot stabs 132 are arranged at the same set distance from the axis 101. The offset hot stab 132a may be arranged closer to the axis 101 than the other hot stabs 132. The hot stabs 132 are disposed at the corners of the first plate 126. The offset hot stab 132a is located further away from its respective corner than the other hot stabs 132. In examples, the hot stabs may be arranged asymmetrically about a plane along which the axis 101 sits. The hot stab receptacles 152 are arranged such that at least one offset hot stab receptacle 152a is arranged at a distance from the axis 101 different from the distance of the other hot stabs receptacles 152 to the axis 101. The remaining hot stab receptacles are arranged at the same set distance from the axis. The offset hot stab 132a corresponds to the offset hot stab receptacle 152a. The offset hot stab 132a is in axial alignment with the offset hot stab receptacle 152a. In this example, the offset hot stab 132a and its corresponding offset hot stab receptacle 152a are arranged closer to the primary axis 101 than the other hot stabs 132. This allows the connection apparatus to be aligned such that each connector locates in its corresponding receptacle.

If the first plate 126 is rotated relative to the second plate 146 during assembly, the hot stabs 132 will not be in alignment with their corresponding hot stab receptacles 152 and so (with the offset arrangement described above) it will not be possible to move the connection apparatus into a coupled position in which the respective hot stabs are received in their respective hot stab receptacles. The offset hot stab 132a also allows for the electrical connectors 134 to be aligned and received by their respective electrical connector receptacles 154. This ensures the correct connector receptacles receive the correct connectors.

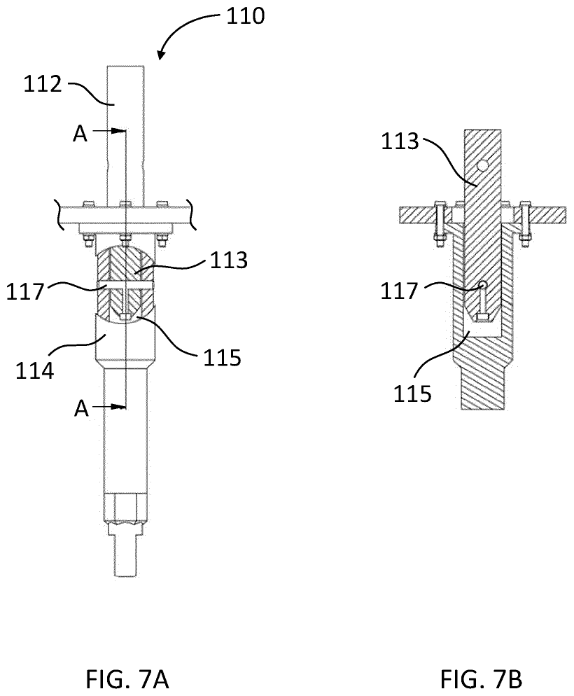

At least in some examples, the connection apparatus 100 comprises an alignment assembly. The alignment assembly comprises a first alignment feature 112 on the first plate 126 and a second alignment feature 114 on the second plate 146. The first alignment feature 112 comprises an alignment pin 113 in the example shown. The alignment pin 113 depends from the first plate 126 in the axial direction. The second alignment feature 114 comprises an alignment receptacle 115. The alignment receptacle 115 depends from the second plate 146 in the axial direction. The alignment receptacle 115 is configured to be axially aligned with the alignment pin 115. The alignment pin 113 is received axially into the alignment receptacle 115 during assembly of the connection apparatus 100. An example alignment assembly is shown in FIGS. 7A and 7B.

The alignment assembly may additionally comprise a locking arrangement to restrict axial movement of the first alignment feature relative to the second alignment feature so as to lock the connection apparatus in the coupled position. The locking arrangement may comprise a shear pin 117 (shown in detail in FIGS. 7A and 7B). The shear pin 117 is configured to restrict axial movement of the first alignment feature relative to the second alignment feature until a threshold force is applied to the alignment assembly. The threshold force may be a pre-determined force which acts to move the first and second parts away from each other. Once the force threshold is reached, the shear pin 117 breaks and the alignment assembly can axially separate, allowing the first and second parts of the connection apparatus to separate enough to break the connection between the first and second service lines 122, 142. This provides for an emergency release system when a set axial force is applied to the connection apparatus 100. The shear pin 117 may be inserted after the first and second parts 120, 140 have been moved into the coupled position. The shear pin 117 may be inserted through corresponding holes in the alignment receptacle 115 and alignment pin 113 to extend across the alignment receptacle 115 and alignment pin 113 to axially restrict movement of the alignment assembly and therefore restrict relative axial movement between the first and second parts 120, 140. The shear pin 117 may be a spring loaded pin that is biased into a receiving hole within the alignment receptacle 115.

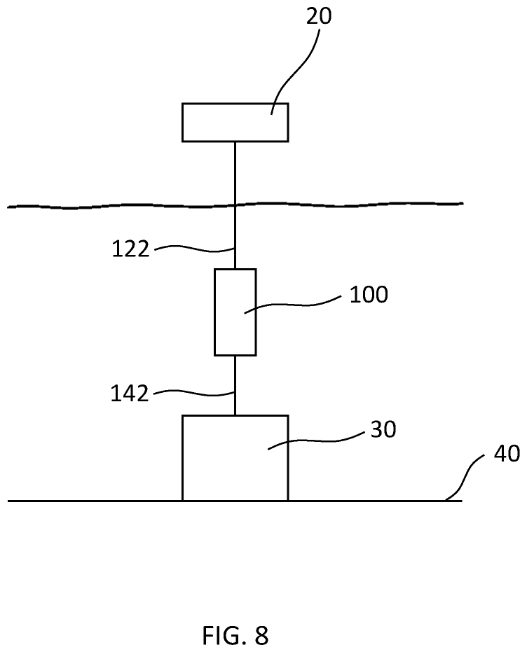

A first attachment arrangement 121 is connected to the first plate 126. A second attachment arrangement 141 is connected to the second plate 146. The first attachment arrangement 121 is connected to the first plate 126 and may for example attach to a first structure such as a platform or surface vessel 20 (shown in FIG. 8). The first attachment arrangement 121 depends away from the first plate 126 and in a direction opposed to the hot stabs 132. The first attachment arrangement 121 may comprise a bracket and a mechanical linkage such as a chain connected to the bracket. The second attachment arrangement 141 is connected to the second plate 142 and may for example attach to a second structure such as an underwater structure 30 (shown in FIG. 8). The second attachment arrangement 141 depends away from the second plate 146 and in a direction the same as the hot stab receptacles 152. The second attachment arrangement 141 may comprise a bracket and a mechanical linkage such as a chain connected to the bracket. The first and second attachment arrangements 121, 141 are aligned along the primary axis 101. The first and second attachment arrangements 121, 141 may be off axis to the primary axis 101. The first attachment arrangement 121 is in axial alignment with the first alignment feature 112. The first alignment feature 112 may be attached to the first attachment arrangement 121. The second attachment arrangement 141 is in axial alignment with the second alignment feature 114. The second alignment feature 114 may be attached to the second attachment arrangement 141.

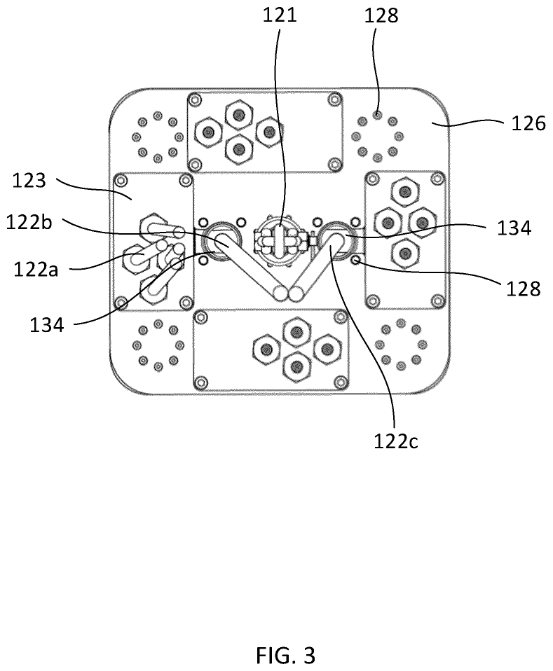

FIG. 3 shows a top view of the example connection apparatus of FIG. 1 with the service lines 122a for one hot stab 132 connected to the first plate 126. A further service line 122b connects to one electrical connector 134, and a further service line 112c connects to another electrical connector 134.

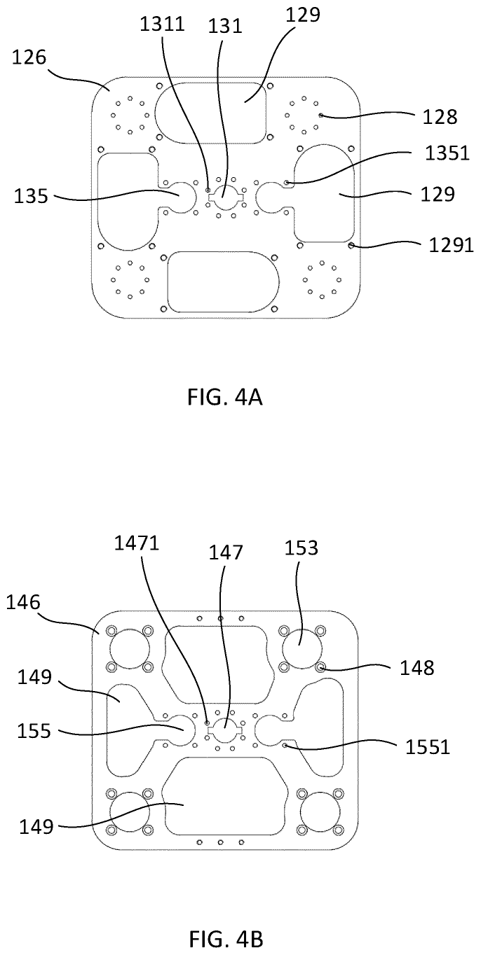

FIG. 4A shows the first plate 126 of the example connection apparatus with no connectors attached. The first plate 126 comprises an alignment hole 131 for attachment of the alignment pin 113 to the first plate 126. The alignment pin 113 is attached at attachment holes 1311 to depend from the first plate 126 in the first direction. The attachment holes 1311 may be holes in the first plate 126 to allow the first alignment pin 113 to be attached to the first plate 126. The first plate 126 comprises attachments holes 128, 1351 to which the hot stabs and electrical connectors are attached respectively to depend from the first plate 126 in the first direction. The attachment holes 128, 1351 may be holes in the first plate 126 to allow the hot stabs and electrical connectors to be bolted to the first plate 126. Other attachment means may be used. The first plate 126 comprises service line holes 129 through which the service lines for the hot stabs 132 pass through. Electrical connector holes 135 allow for the electrical connectors 134 to pass through the first plate 126. FIG. 3 shows the hot stab service lines 112a being fed through the service line holes 129 and secured by a service line plate 123. The plate 123 holds the service lines 122a in place and allows them to be connected to the side of the hot stab 132. The plate 123 is attached to the first plate 126 by attachment holes 1291. The attachment holes 1291 may be holes that allow the plate 123 to be bolted to the first plate 126. The top of the hot stab 132 is attached to the first plate 126 so the service lines 122a must be attached at the side of the hot stab 132. The first alignment hole 127 allows for the first attachment arrangement 121 and first alignment feature 112 to attach to the first plate 126.

FIG. 4B shows the second plate 146 of the example connection apparatus with no connectors attached. The second plate 146 comprises an alignment hole 147 around which the alignment receptacle 115 is attached to depend in the first direction. The alignment receptacle 115 is attached at the attachment holes 1471. During coupling, the alignment pin 113 is inserted through the alignment hole 147 and into the alignment receptacle 115. The second plate 146 comprises attachment holes 148 to which the hot stab receptacles 152 are attached to depend from the second plate 146 in the first direction. The second plate 146 comprises attachment holes 1551 to which the electrical connector receptacles 154 are attached to depend from the second plate 146 in the first direction. Electrical connector holes 155 allow for the electrical connector receptacles 154 to pass through the second plate 156. During coupling, the hot stabs 132 are inserted through the hot stab hole 153 to be received in their corresponding hot stab receptacles 152. The second alignment hole 147 allows for the second attachment arrangement 141 and second alignment feature 114 to attach to the second plate 146. Cut-outs 149 formed in the second plate 146 provide for a material saving of the second plate 146 whilst retaining its strength. The first and second plates 126, 146 and any other components of the connection apparatus may be made of any suitable material, including metal, for example, stainless steel.

During coupling of the connection apparatus 100, the first plate 126 is moved towards the second plate 146 to engage the alignment assembly, by connecting the first alignment feature 112 with the second alignment feature 114 along the primary axis 101. Due to the movement of the first plate towards the second plate, the hot stabs 132 are inserted into their respective hot stab receptacles 152. The electrical connecters 134 are also inserted into the electrical connector receptacles 154. The arrangement of the connectors, the connector receptacles and the alignment assembly allows the connection apparatus 100 to be aligned during assembly and prevents mis-alignment of any of the connectors.

To uncouple the connection apparatus 100, the first part 120 is pulled away from the second part 140 along the primary axis 101. In some examples, an upwards force is applied to the first attachment arrangement 121, while the second attachment arrangement 142 remains anchored to an underwater structure, thus preventing the second part 120 from moving upwards with the first part 140. Where the alignment assembly comprises a locking arrangement such as a shear pin 117, the shear pin 117 will break when the breakaway force reaches a set threshold. After the shear pin 117 has broken, the alignment assembly separates to allow the first and second parts 120, 140 to separate. The first and second parts 120, 140 may be fully separated in at least some examples to allow removal of the first or second part from the connection apparatus. The hot stabs 132 are therefore removed from the hot stab receptacles 152, and the electrical connectors 134 are disconnected from the electrical connector receptacles 154. The first part 120 and second part 140 can then be brought up to the surface for servicing, re-assembly and/or repair if required. In some other examples, the first and second parts may only be separated enough to break the connection between the service lines. In this case, the hot stabs may not be fully removed from the receptacles, and the electrical connectors may not be fully removed from the connector receptacles.

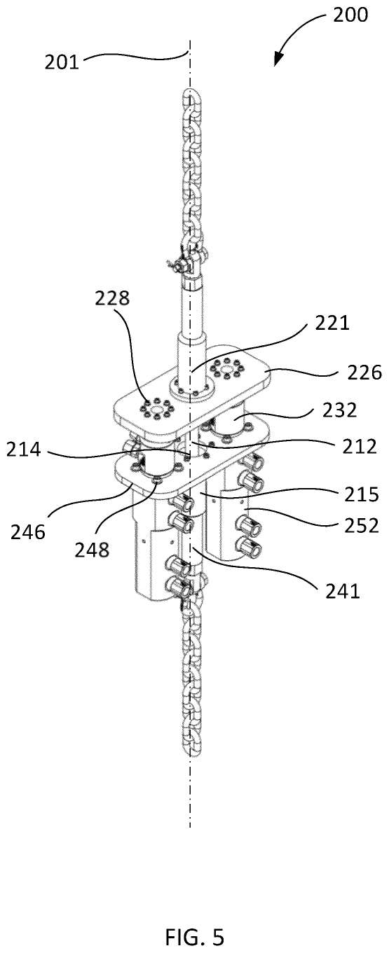

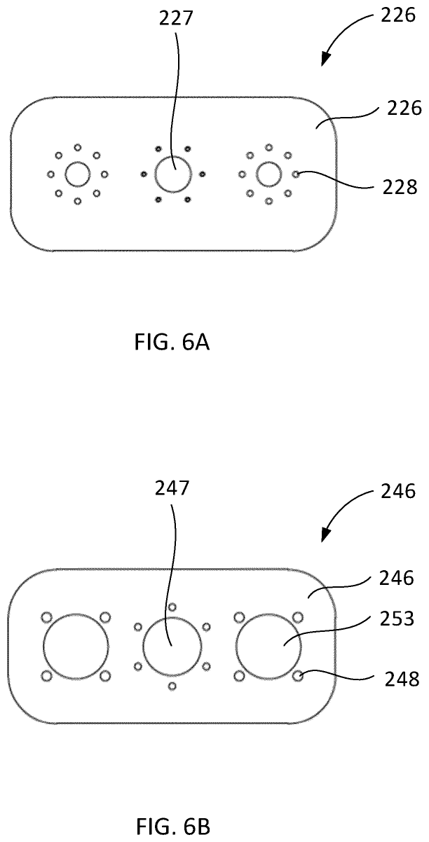

FIG. 5 shows an alternative example of the invention wherein the connection apparatus 200 comprises only two hot stabs 232. FIGS. 6A and 6B show the first plate 226 and the second plate 246 of the alternative connection apparatus 200 alone before attachment of any hot stabs, receptacles or attachment arrangements. The two hot stabs are arranged diametrically around the primary axis 201. The hot stabs 232 may be arranged non-symmetrically around the axis 201. The first plate 226 comprises a first attachment arrangement 221 and a first alignment feature 212. The second plate 246 comprises a second attachment arrangement 241 and a second alignment feature 214. The hot stabs are received by receptacles 252. The hot stabs are connected to the first plate 226 by attachment holes 228. The hot stab receptacles 252 are connected to the second plate 246 by attachment holes 248. The alignment hole 227 on the first plate 226 allows for attachment of the first alignment feature 212 and the first attachment arrangement 221. The alignment hole 247 on the second plate 246 allows for attachment of the second alignment feature 214 and the second attachment arrangement 241. The hot stabs 232 are inserted into the receptacle holes 253 during assembly, such that the hot stabs 232 can be inserted into the hot stab receptacles 252.

It will be understood that the present disclosure also extends to a method of making a connection apparatus according to any of the examples described above for forming a connection between respective service lines in a subsea environment. The method includes providing a first mount, optionally a first plate, and forming a plurality of apertures in the first mount. Each connector is aligned with and extends from one of the plurality of apertures in the first mount. The method also includes attaching a plurality of connectors to the first mount so as to depend from the first mount. In any example, at least one of the plurality of connectors is a hot stab.

A second mount, optionally a second plate, is also provided and a plurality of apertures are formed in it. The method then includes attaching a plurality of receptacles to the second mount so as to depend from the second mount. Each receptacle is aligned with and extends from one of the plurality of apertures in the second mount. Each receptacle of the plurality of receptacles corresponds to a connector of the plurality of connectors, such that each of the plurality of connectors is configured to be received by one of the plurality of receptacles when the connection apparatus is moved into the coupled position.

The connection apparatus according to any example of the disclosure is assembled by bringing the first and second parts into engagement. This connects the hot stabs and electrical and/or fibre optic connectors with their corresponding receptacles to provide a connection between the first and second sets of service lines.

The method of assembly will be described in relation to the first example of the invention disclosed in FIGS. 1 to 4. The first part 120 is brought into axial alignment with the second part 140. In some examples, the first and second parts 120, 140 are aligned by means of an ROV acting subsea. In other examples, for example when the connection apparatus is being assembled above the surface of the sea or topside, the first and second parts 120, 140 are aligned manually.

The first and second parts 120, 140 are aligned such that the alignment pin 113 is in axial alignment with the alignment receptacle 115, the hot stabs 132 are in axial alignment with their corresponding hot stab receptacles 152, and the electrical connectors 134 are in axial alignment with their corresponding electrical connector receptacles 154. The first and second parts 120, 140 are then brought together to insert the alignment pin 113 into the alignment receptacle 115. The hot stabs 132 are inserted into their corresponding hot stab receptacles 152, and the electrical connectors 134 are inserted into their corresponding electrical connector receptacles 154. The first and second part 120, 140 are moved towards each other along the axis 101 by the ROV. The first and second parts 120, 140 are brought together until the hot stabs 132 are received fully in their corresponding hot stab receptacles 152 such that they provide a fluid connection between the first and second service lines 122, 142. The electrical connectors 134 are fully received in their corresponding electrical connector receptacles 154 to provide an electrical connection between the first and second service lines 122, 142. The assembly of the first and second parts 120, 140 provides low friction for easy assembly without the need for additional assembly parts. The shear pin 117 is activated to limit relative axial movement between the alignment pin 113 and the alignment receptacle 115, and therefore the first and second parts 120, 140.

The connection apparatus 100 is disassembled by applying an axial force to separate the first and second parts 120, 140. Tension is applied to the first attachment arrangement 121 and the second attachment arrangement 141 to separate the first and second parts 120, 140. The first and second parts 120, 140 are disconnected subsea. The connection between the first and second service lines 122, 142 is broken by at least partially removing the hot stabs 132 from their respective hot stab receptacles 152, and at least partially removing the electrical connectors 134 from their respective electrical connector receptacles 154. The force required to break the service line connection is low to allow for easy disassembly in emergency situations. The shear pin 117 provides a pre-set breaking force. On application of the pre-set breaking force, the shear pin 117 will break, and allow the first and second parts 120, 140 to separate and break the connection between the first and second service lines 122, 142.

FIG. 8 shows a schematic representation of the connection assembly 100 in a subsea environment. In the example shown, the connection assembly 100 is connected by the first set of service lines 122 to a surface structure 20 above the surface. The surface structure 20 may be a vessel. The connection assembly 100 is connected by the second set of service lines 142 to a subsea structure 30. The subsea structure 30 is at or near the sea bed 40.

While the disclosure has been described in detail in connection with only a limited number of examples, it should be readily understood that the disclosure is not limited to such disclosed examples. Rather, the disclosure can be modified to incorporate any number of variations, alterations, substitutions or equivalent arrangements not heretofore described, but which are commensurate with the scope of disclosure. Additionally, while various examples of the disclosure have been described, it is to be understood that aspects of the disclosure may include only some of the described examples. Accordingly, the disclosure is not to be seen as limited by the foregoing description, but is only limited by the scope of the appended claims.

1. A connection apparatus for forming a connection between respective service lines in a subsea environment, the connection apparatus comprising:
a first part comprising a plurality of connectors configured to be connected to a first set of service lines, and a first mount, the plurality of connectors being disposed on and depending from the first mount, wherein at least one of the plurality of connectors is a hot stab;
a second part comprising a plurality of receptacles configured to be connected to a second set of service lines, and a second mount, the plurality of receptacles being disposed on and depending from the second mount, each receptacle of the plurality of receptacles corresponding to a connector of the plurality of connectors, wherein at least one of the plurality of receptacles is a hot stab receptacle; wherein the connection apparatus is movable between a coupled position and an uncoupled position; wherein in the coupled position, each connector of the plurality of connectors is received in its corresponding receptacle and a connection is formed between the respective service lines; and in the uncoupled position, there is no connection between the respective service lines.

2. The connection apparatus of claim 1, wherein at least one of the plurality of connectors is an electrical connector and at least one of the plurality of receptacles is an electrical connector receptacle, and/or or wherein at least one of the plurality of connectors is a fibre-optic connector and at least one of the plurality of receptacles is a fibre-optic connector receptacle.

3. The connection apparatus of claim 1, wherein the connection apparatus is configured to move from the coupled position to the uncoupled position on application of a pre-determined force which acts to move the first and second parts away from each other.

4. The connection apparatus of claim 1, further comprising a locking arrangement configured to lock the connection apparatus in the coupled position.

5. The connection apparatus of claim 4, wherein the locking arrangement is configured to release on application of the pre-determined force.

6. The connection apparatus of claim 1, further comprising an alignment assembly for aligning the plurality of connectors of the first part with the plurality of receptacles of the second part.

7. The connection apparatus of claim 6, the alignment assembly comprising:
a first alignment feature on the first part, and
a second alignment feature on the second part,
wherein the first and second alignment features are configured to engage in the coupled position.

8. The connection apparatus of claim 7, wherein the first alignment feature comprises an alignment pin, and wherein the second alignment feature comprises an alignment receptacle which is configured to receive the alignment pin.

9. The connection apparatus of claim 1, wherein the plurality of connectors are positioned on the first mount and the plurality of receptacles are positioned on the second mount such that each respective one of the plurality of connectors may be received only in a chosen one of the plurality of receptacles when the connection apparatus is in the coupled position.

10. The connection apparatus of claim 1, wherein the first part comprises a first attachment arrangement configured to attach the first part to a first structure, and/or wherein the second part comprises a second attachment arrangement configured to attach the second part to a second structure.

11. A method of making a connection apparatus as recited in claim 1 for forming a connection between respective service lines in a subsea environment, the method comprising:
providing a first mount;
attaching a plurality of connectors to the first mount so as to depend from the first mount, wherein at least one of the plurality of connectors is a hot stab;
providing a second mount; and
attaching a plurality of receptacles to the second mount so as to depend from the second mount, wherein each receptacle of the plurality of receptacles corresponds to a connector of the plurality of connectors, such that each of the plurality of connectors is configured to be received by one of the plurality of receptacles when the connection apparatus is moved into the coupled position.

12. The method of claim 11, further comprising:
forming a plurality of apertures in the first mount, wherein each connector is aligned with and extends from one of the plurality of apertures in the first mount; and/or
forming a plurality of apertures in the second mount, wherein each receptacle is aligned with and extends from one of the plurality of apertures in the second mount.

13. A method of forming a connection between respective service lines in a subsea environment using a connection apparatus as claimed in claims 1 to 10, the method comprising:
connecting the plurality of connectors of the first part to a first set of service lines;
connecting the plurality of receptacles of the second part to a second set of service lines;
and moving the connection apparatus into the coupled position.

14. The method of claim 13, wherein the connection apparatus is moved into the coupled position by moving the first part towards the second part and I or moving the second part towards the first part.

15. The method of claim 13, wherein the connection apparatus is moved into the coupled position by an ROV or by an actuator, for example a hydraulic actuator.

16. The method of any of claim 13, further comprising aligning the plurality of connectors with the plurality of receptacles before or while moving the connection apparatus into the coupled position.

17. A method of breaking a connection between respective service lines in a subsea environment, wherein the connection is formed by a connection apparatus as claimed in claim 1, the method comprising: moving the first and second part away from each other to move the connection apparatus to the uncoupled position.
